(19) United States
(12) Patent Application Publication
(10) Pub. No.: US 2016/0199852 A1
(43) Pub. Date: Jul. 14, 2016

(54) NEGATIVE DIELECTROPHORETIC (N-DEP) FORCE BASED CELL SORTING PLATFORM AND CELL SORTING METHOD USING THE SAME

(71) Applicant: Industry-University Cooperation Foundation Korea Aerospace University, Goyang-si (KR)

(72) Inventors: Byung Kyu Kim, Gimpo-si (KR); Dong Kyu Lee, Goyang-si (KR); Bo Hyun Hwang, Seoul (KR); Deog Moon Rho, Seoul (KR); Jun Woo Choi, Goyang-si (KR)

(21) Appl. No.: 14/749,250

(22) Filed: Jun. 24, 2015

(30) Foreign Application Priority Data
Jan. 12, 2015 (KR) 10-2015-0004375

(51) Int. Cl. B03C 5/00; B03C 5/02

(52) U.S. Cl. CPC B03C 5/005; B03C 5/022

(57) ABSTRACT

Provided is a cell sorting platform including a housing, a first electrode substrate extending inside the housing, and a second electrode substrate extending inside the housing and disposed parallel to the first electrode substrate with a predetermined gap, facing the first electrode substrate, wherein each electrode is formed at one side of the first electrode substrate and the second electrode substrate, and a plurality of electrode arrays is formed extending with an inclination from each of the electrodes, and a cell sorting method using the same.

### CROSS-REFERENCE TO RELATED APPLICATION

This application claims priority to Korean Patent Application No. 10-2015-0004375, filed on Jan. 12, 2015, and all the benefits accruing therefrom under 35 U.S.C. §119, the contents of which in its entirety are herein incorporated by reference.

### BACKGROUND

1. Field

The present disclosure relates to a cell sorting platform using a negative dielectrophoretic force, and more particularly, to a cell sorting platform with a simple structure that allows the quick separation of target particles from mixed cells (target and non-target cells) in a aqueous solution and maximizes the throughput and separation efficiency of particle separation and a cell sorting method using the same.

2. Description of the Related Art

In the fields of medical diagnosis and pathology, separation and treating of particles in biological cells has been studied. Also, in the modern medical field such as detection of pathogenic bacteria, drug development, drug tests, and cell replacement therapies, operations of sorting and separating target cells are indispensable.

Along with these studies in the medical field, recently, with the development of micro electro mechanical system (MEMS) technology, studies are being made on various separation devices in the medical field.

For example, in dielectrophoresis (DEP), it is well known that dielectrically polarizable particles in a non-uniform electric field experience a dielectrophoretic force (DEP force) when effective polarizability of the particles is different from polarizability of the surrounding medium although the particles are not charged. The movement of the particles is determined, as known in dielectrophoresis, by the dielectric properties (conductivity and permittivity) of the particles and the surrounding medium, rather than by the electric charge of the particles. Also, in the case of general particle separation systems using a DEP force, because it is necessary to use an expensive microsyringe pump together and a large number of components, there are disadvantages of an overall complex system and a very high cost.

To solve these problems, systems for separating particles in the vertical direction using gravity have been developed with an aim of simplifying the device, and examples of such particle separation systems include particle separation systems shown in FIGS. 1 and 2.

The particle separation system of related art 1 as shown in FIG. 1 uses a method which radially sorts and separates particles being fed.

However, the particle separation system disclosed in the related art 1 has disadvantages of complex assembling of the system because the entire system should be radially built, and due to a low particle separation throughput, requiring a great deal of time to treat a large amount of samples, resulting in low efficiency.

Also, the particle separation system of related art 2 as shown in FIG. 2 includes an electrode array placed on a path along which particles move in the direction of gravity in the form of a cantilever or a bridge, and separates particular particles through deflection according to sizes and dielectric properties of the particles.

However, similar to the related art 1, the particle separation system of the related art 2 also has disadvantages of a large number of components in the separation system and consequential complex assembling of the entire system.

### RELATED ART

(Related art 1) Korean Patent Publication No. 1284725

(Related art 2) Korean Patent Publication No. 1023040

### SUMMARY

Therefore, the present disclosure aims to propose a particle separation device which may reduce complexity of assembling by minimizing the number of components in the particle separation systems of the related arts 1 and 2, and at the same time, may significantly improve the throughput of the particle separation system by setting a greater length of an electrode array compared to width of an electrode.

To achieve the above object, there is provided a particle separation device, more particularly, a cell sorting platform including a housing, a first electrode substrate extending inside the housing, and a second electrode substrate extending inside the housing, and disposed parallel to the first electrode substrate with a predetermined gap, facing the first electrode substrate, wherein each electrode is formed at one side of the first electrode substrate and the second electrode substrate, and a plurality of electrode arrays is formed extending with an inclination from each of the electrodes.

Also, the cell sorting platform may be provided in which the plurality of electrode arrays of the first electrode substrate and the plurality of electrode arrays of the second electrode substrate according to the present disclosure are arranged symmetrically to each other, and the plurality of electrode arrays are respectively disposed parallel to each other side by side.

Also, the cell sorting platform may be provided in which a number of the plurality of electrode arrays of the first electrode substrate and a number of the plurality of electrode arrays of the second electrode substrate according to the present disclosure is each at least three for separation efficiency of target cells, a width of the first electrode substrate and the second electrode substrate is greater than a channel height (of the first electrode substrate and the second electrode substrate), and a length of the plurality of electrode arrays is set based on the width of the first electrode substrate and the second electrode substrate.

Also, an injection unit may be further included on top of the first electrode substrate and the second electrode substrate according to the present disclosure to inject an aqueous solution including the target particles and non-target particles, and the injection unit may change an injection velocity of the aqueous solution including the target particles and non-target particles.

Also, voltage and frequency being applied to the electrodes of the first electrode substrate and the second electrode substrate according to the present disclosure may be applied and cut off repeatedly, and the cell sorting platform may be provided in which the cell sorting platform further includes a collection unit formed at bottom of the first electrode substrate and the second electrode substrate, the collection unit including a plurality of first collection units to collect the separated target particles and a plurality of second collection units to collect the non-target particles free of the separated target particles.

Also, there is provided a cell sorting method using the above cell sorting platform including generating an electric field by applying voltage and frequency to the electrode of the first electrode substrate and the electrode of the second electrode substrate based on properties of target particles, injecting an aqueous solution including the target particles and non-target particles, separating the target particles by deflecting the target particles based on sizes and dielectric properties of the target particles and aqueous solution, repeating the application and cut off of the voltage and frequency being applied to the electrode of the first electrode substrate and the electrode of the second electrode substrate at a predetermined time interval, and collecting the separated target particles.

According to the present disclosure, as the plurality of electrode arrays is arranged with an inclination with respect to a path along which particles move in the direction of gravity, high-speed and high-efficiency cell separation is enabled through separation based on sizes and dielectric properties of cells and aqueous solution.

Also, because creation and annihilation of the electric field is repeated during separation of target particles, an entanglement or accumulation phenomenon between the target particles may be prevented.

Also, because a greater width of the electrode substrate than channel height between the electrode substrates is set, throughput of particle separation may be maximized by setting a great length of the electrode array formed on the electrode substrate.

Also, the present disclosure may reduce complexity of assembling and achieve high recovery rate by minimizing a number of components in the entire sorting platform, and at the same time, may significantly improve the throughput of the particle separation system by setting a greater length of the electrode array compared to width of the electrode.

### BRIEF DESCRIPTION OF THE DRAWINGS

FIG. 1 is a schematic diagram of a particle separation system using a dielectrophoretic force according to a related art 1.

FIG. 2 is a schematic diagram of a particle separation system using a dielectrophoretic force according to a related art 2.

FIG. 3 is a schematic diagram of a cell sorting platform according to an exemplary embodiment of the present disclosure.

FIG. 4 is a schematic diagram of a first electrode substrate and a second electrode substrate separated from a cell sorting platform according to an exemplary embodiment of the present disclosure.

FIG. 5 is a plane view of a first electrode substrate and a second electrode substrate of a cell sorting platform according to an exemplary embodiment of the present disclosure.

FIG. 6 is a schematic diagram of forces acting on target particles, in a cell sorting platform according to an exemplary embodiment of the present disclosure.

FIG. 7 is a schematic diagram of a process of separating target particles using a cell sorting platform according to an exemplary embodiment of the present disclosure.

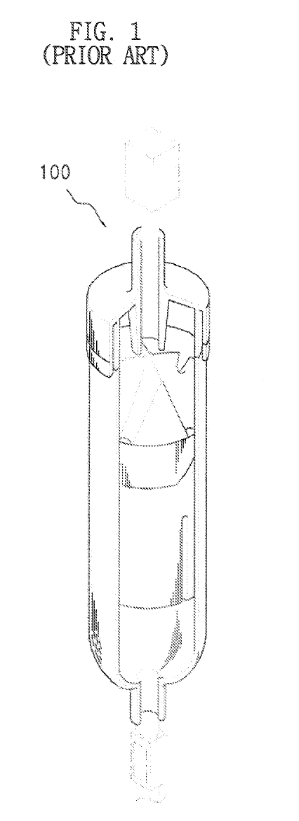

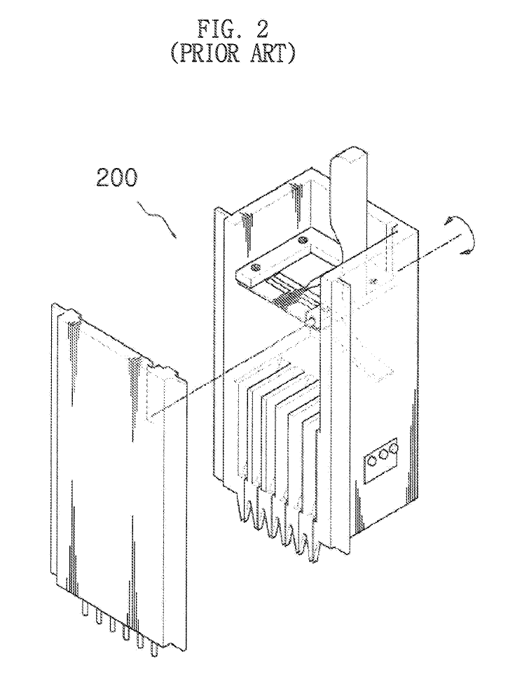

### DETAILED DESCRIPTION

Hereinafter, a description of construction and operation of a cell sorting platform according to the present disclosure and a cell sorting method using the cell sorting platform 1 is provided through the exemplary embodiments of the present disclosure with reference to the accompanying drawings.

Prior to the description, in several embodiments, elements having the same configuration are representatively described in one embodiment by using the same reference numerals while other elements will be only described in other embodiments.

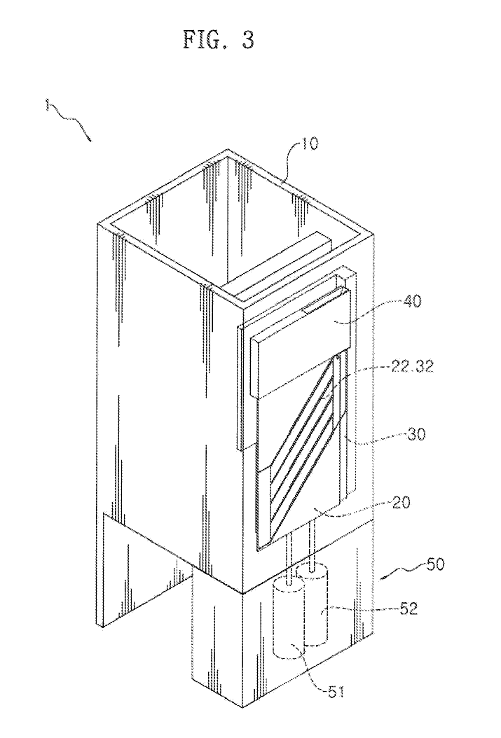

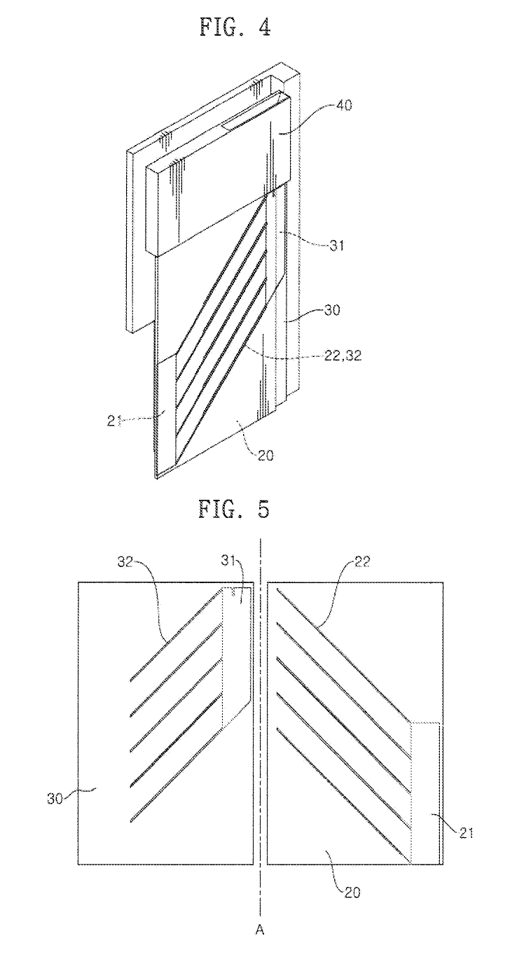

FIG. 3 is a schematic diagram of the cell sorting platform 1 according to an exemplary embodiment of the present disclosure, and FIG. 4 is a schematic diagram of a first electrode substrate 20 and a second electrode substrate 30 of the present disclosure separated from a housing 10.

Also, FIG. 5 is a plane view for further detailed illustration of the first electrode substrate 20 and the second electrode substrate 30 of the cell sorting platform 1 according to the present disclosure.

The cell sorting platform 1 according to an exemplary embodiment of the present disclosure includes the housing 10 and the first electrode substrate 20 and the second electrode substrate 30 which are mounted in the housing 10, and when the first electrode substrate 20 and the second electrode substrate 30 are mounted in the housing 10, the first electrode substrate 20 and the second electrode substrate 30 may be vertically mounted within the housing 10.

Also, the first electrode substrate 20 and the second electrode substrate 30 are arranged parallel to each other with a predetermined gap W.

As shown in FIG. 4, an injection unit 40 is formed on top of the first electrode substrate 20 and the second electrode substrate 30 to inject an aqueous solution including target particles P and non-target particles NP.

Also, a collection unit 50 is formed at bottom of the first electrode substrate 20 and the second electrode substrate 30, including a plurality of first collection units 51 and a plurality of second collection units 52 to collect separated target particles P and the non-target particles free of the separated target particles, respectively.

As shown in FIGS. 4 and 5, electrodes 21 and 31 are formed at one side of the first electrode substrate 20 and the second electrode substrate 30, respectively, and a plurality of electrode arrays 22 and 32 extend from the electrodes 21 and 31 with an inclination with respect to the electrode substrates 20 and 30, respectively.

As explained above, the first electrode substrate 20 and the second electrode substrate 30 are arranged facing each other, and for example, when it is assumed that folding is performed along a line of symmetry A shown in FIG. 5, positions of the plurality of electrode arrays 22 of the first electrode substrate 20 and positions of the plurality of electrode arrays 32 of the second electrode substrate 30 are arranged symmetrically to each other.

Although a number of the plurality of electrode arrays 22 and 32 of each of the electrode substrates 20 and 30 is not particularly limited, separation efficiency of target particles P was found high when at least two electrode arrays are formed, and to further improve the separation efficiency, it is desirable to form a plurality of additional electrode arrays 22 and 32 other than the two.

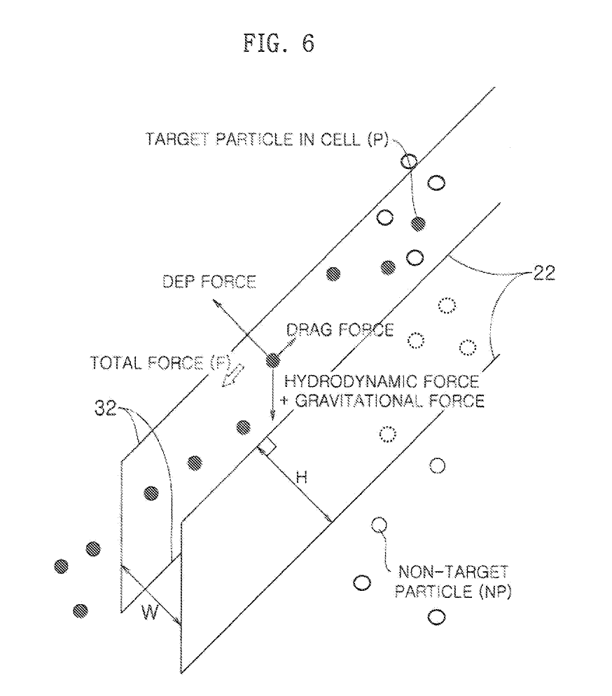

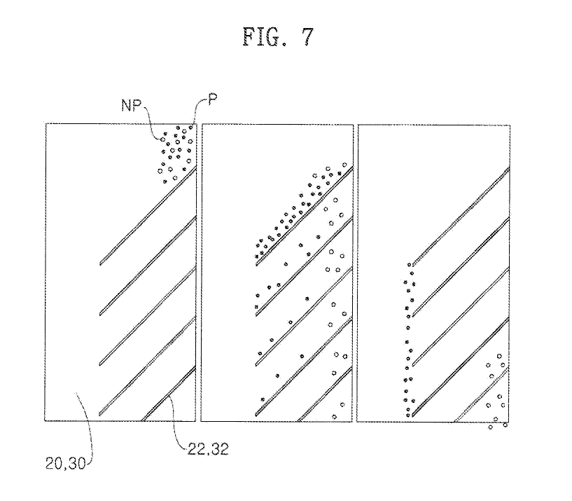

FIG. 6 shows forces acting on target particles P when the target particles P are disposed between the electrode arrays 22 and 32 of the first electrode substrate 20 and the second electrode substrate 30 facing each other, in the cell sorting platform 1 of the present disclosure.

As shown in FIG. 6, a dielectrophoretic (DEP) force, a drag force, a hydrodynamic force, and a gravitational force act on the target particles P, and a total force F acts in the down slope direction of the electrode arrays 22 and 32, and as a result, the target particles P move in the down slope direction.

The gap W between the first electrode substrate 20 and the second electrode substrate 30 facing each other, i.e., the gap W between the electrode arrays 22 and 32, and a vertical width H of each of the electrode arrays 22 and 32 may be suitably modified based on the properties (conductivity and permittivity) of the target particles P, and in this embodiment, the gap W between the electrode arrays 22 and 32 was set to 200 μm, and the vertical width H of the electrode arrays 22 and 32 was set to 200 μm.

Also, in this embodiment, a slope θ of the electrode arrays 22 and 32 was set to 45°, and similarly, the slope θ of the electrode arrays 22 and 32 may be suitably modified based on the properties of the target particles P.

Hereinafter, a process of separating target particles P using the cell sorting platform 1 according to an exemplary embodiment of the present disclosure is described with reference to FIG. 7. For reference, in an exemplary embodiment of the present disclosure according to FIG. 7, five electrode arrays 22 and 32 were formed.

First, an aqueous solution including target particles P and non-target particles NP is prepared, and voltage and frequency is applied to the electrode 21 of the first electrode substrate 20 and the electrode 31 of the second electrode substrate 30 based on the properties of the target particles P to generate an electric field.

The electric field generated from the electrode 21 of the first electrode substrate 20 and the electrode 31 of the second electrode substrate 30 is also equally generated around the electrode arrays 22 and 32 respectively extending from the electrodes 21 and 31.

Subsequently, the aqueous solution including target particles P and non-target particles NP is injected through the injection unit 40. The injection unit 40 may suitably change a velocity of injection of the aqueous solution including target particles P and non-target particles NP based on the properties of the target particles P. Also, due to having a funnel-shaped internal shape with a cross-sectional area decreasing in the downward direction, the injection unit 40 may inject intensively into the rightmost upper edge of the first electrode substrate 20 and the second electrode substrate 30. In the embodiment shown in FIG. 7, injection was performed in parallel through the upper sides of the first electrode substrate 20 and the second electrode substrate 30.

The injected target particles P and non-target particles NP moves down in the vertical direction due to the gravity. Subsequently, when target particles P and non-target particles NP reaches the topmost (first electrode array) of the electrode arrays 22 and 32, it is affected by the electric field generated around the electrode arrays 22 and 32. Thus, as shown in FIG. 6, through the total force F, the target particles P move in the down slope direction of the first electrode array along the first electrode array, and at the end of the first electrode array where the influence of the electric field does not take effect, the target particles P move down in the vertical direction.

In this instance, there is a likelihood that the first electrode array may not sort out all the target particles P, and thus, some target particles P may be included in the aqueous solution having moved down in the vertical direction of the first electrode array.

Some target particles P and non-target particles NP reaches a second electrode array disposed parallel to the first electrode array side by side. Similar to the first electrode array, some target particles P are separated at the second electrode array, and when the separated target particles P reach the end of the second electrode array, they move down in the vertical direction.

Also, although the passage through the second electrode array was done, likewise, some target particles P may be included, and they may be separated while passing through third through fifth electrode arrays disposed below the second electrode array in a sequential order.

Finally, particles separated through the first through fifth electrode arrays 22 and 32 move down in the vertical direction and are collected through the plurality of first collection units 51 of the collection unit 50, and the non-target particles NP having passed through the fifth electrode array. The target particles P are collected at the plurality of first collection units 51 of the collection unit 50. The non-target particles NP is collected at the plurality of second collection units 52 of the collection unit 50.

While the target particles P are passing through the plurality of electrode arrays 22 and 32, an entanglement or accumulation phenomenon between the particles may occur. To prevent this phenomenon, the voltage and frequency being applied to the plurality of electrode arrays 22 and 32 may be applied and cut off repeatedly (gate mode) at a predetermined time interval. This repetition cycle may be set within a period of time during which a rate of deflection of the target particles is maintained, that is, normal separation is enabled.

Also, when a greater width to height of the first electrode substrate 20 and the second electrode substrate 30 is set, separation efficiency and throughput of the target particles may be further improved, and in this case, because the plurality of first collection units 51 and second collection units 52 is formed (although not shown), the separated target particles P and non-target particles NP may be collected in a large amount.

Therefore, by use of the cell sorting platform 1 according to an exemplary embodiment of the present disclosure, the separation efficiency of the target particles P may be remarkably improved. Also, the cell sorting platform 1 may be assembled in a simple manner only by connecting, to the housing 10, the first electrode substrate 20 and the second electrode substrate 30 having the plurality of electrode arrays 22 and 32 arranged therein, and may separate target particles P and non-target particles NP and is thus noticeably effective in terms of cost and time.

As such, it will be understood by those skilled in the art that the present disclosure may be embodied in other particular forms without changing the technical spirit and essential scope of this disclosure.

Therefore, the embodiments described hereinabove are only illustrative in all aspects, not intended to limit the present disclosure to the disclosed embodiments, so it should be understood that the scope of the present disclosure is represented by the appended claims rather than the above detailed description, and all forms of changes or modifications derived from the meaning and scope of the claims and the equivalent concept thereof fall within the spirit and scope of this disclosure.

What is claimed is:

1. A cell sorting platform comprising:
a housing;
a first electrode substrate extending inside the housing; and
a second electrode substrate extending inside the housing, and disposed parallel to the first electrode substrate with a predetermined gap, facing the first electrode substrate,
wherein each electrode is formed at one side of the first electrode substrate and the second electrode substrate, and a plurality of electrode arrays is formed extending with an inclination from each of the electrodes.

2. The cell sorting platform according to claim 1, wherein the plurality of electrode arrays of the first electrode substrate and the plurality of electrode arrays of the second electrode substrate are arranged symmetrically to each other.

3. The cell sorting platform according to claim 2, wherein the plurality of electrode arrays of the first electrode substrate and the plurality of electrode arrays of the second electrode substrate are respectively disposed parallel to each other side by side.

4. The cell sorting platform according to claim 2, wherein a number of the plurality of electrode arrays of the first electrode substrate and a number of the plurality of electrode arrays of the second electrode substrate is each at least three for separation efficiency of target cells.

5. The cell sorting platform according to claim 2, wherein a width of the first electrode substrate and the second electrode substrate is greater than channel height (gap of the first electrode substrate and the second electrode substrate), and a length of the plurality of electrode arrays is set based on the width of the first electrode substrate and the second electrode substrate.

6. The cell sorting platform according to claim 1, further comprising:
an injection unit provided on top of the first electrode substrate and the second electrode substrate to inject an aqueous solution including target particles and non-target particles.

7. The cell sorting platform according to claim 6, wherein the injection unit changes an injection velocity of the aqueous solution including target particles and non-target particles.

8. The cell sorting platform according to claim 1, wherein voltage and frequency being applied to the electrodes of the first electrode substrate and the second electrode substrate is applied and cut off repeatedly.

9. The cell sorting platform according to claim 1, further comprising:
a collection unit formed at bottom of the first electrode substrate and the second electrode substrate, including a plurality of first collection units to collect the separated target particles and a plurality of second collection units to collect non-target particles free of the separated target particles.

10. A cell sorting method using a cell sorting platform defined in claim 1, the cell sorting method comprising:
generating an electric field by applying voltage and frequency to the electrode of the first electrode substrate and the electrode of the second electrode substrate based on properties of target particles;
injecting an aqueous solution including target particles and non-target particles;
separating the target particles by deflecting the target particles based on sizes and dielectric properties of the target particles;
repeating the application and cut off of the voltage and frequency being applied to the electrode of the first electrode substrate and the electrode of the second electrode substrate at a predetermined time interval; and
collecting the separated target particles and the non-target particles.
